(19) United States
(12) Patent Application Publication
(10) Pub. No.: US 2012/0076368 A1
(43) Pub. Date: Mar. 29, 2012

(54) FACE IDENTIFICATION BASED ON FACIAL FEATURE CHANGES

(76) Inventors: David Staudacher, Fort Collins, CO (US); Daniel Bloom, Loveland, CO (US); Dan L. Dallon, Greeley, CO (US)

(21) Appl. No.: 12/891,413

(22) Filed: Sep. 27, 2010

(51) Int. Cl. G06K 9/46

(52) U.S. Cl. 382/118

(57) ABSTRACT

A face is detected within a series of imaging frames. One or more changes to a facial feature of the face are detected in progressive frames of the series. The face is identified based on the detected changes.

### BACKGROUND

Face recognition algorithms examine shapes and locations of individual facial features to detect and identify faces within digital images. However, faces have “deformable” features, such as mouths that can both smile and frown, which can cause problems for face recognition algorithms. Such deformations can vary significantly from person to person, further complicating face recognition in digital images.

### BRIEF DESCRIPTION OF DRAWINGS

The following description includes discussion of figures having illustrations given by way of example of implementations of embodiments of the invention. The drawings should be understood by way of example, not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram illustrating a system according to various embodiments.

FIG. 2 is a block diagram illustrating a system according to various embodiments.

FIG. 3 is a flow diagram of operation in a system according to various embodiments.

### DETAILED DESCRIPTION

Various embodiments described herein use the range and/or motion of facial feature deformations to assist in the face recognition process. As used herein, a facial feature deformation refers to any change in form or dimension of a facial feature in an image, such as a digital image. For example, a mouth is a facial feature that is prone to deformation via smiling, frowning, and/or contorting in various ways. Of course, facial feature deformations are not limited to the mouth. Noses that wrinkle, brows that furrow, and eyes that widen/narrow are further examples of facial feature deformations.

Certain face recognition techniques focus on taking specific measurements of candidate faces and comparing them to similar measurements in a database of known faces. These techniques can be complicated by facial feature deformations. Accordingly, these techniques may involve selecting and/or using measurements that are least affected by deformations. However, these approaches can have a negative impact on the accuracy of results given that fewer measurements are compared, thereby increasing the influence of noise and measurement errors.

In embodiments described herein, various characteristics of facial deformations including, but not limited to, range, velocity, and acceleration are detected and measured from a series of progressive images.

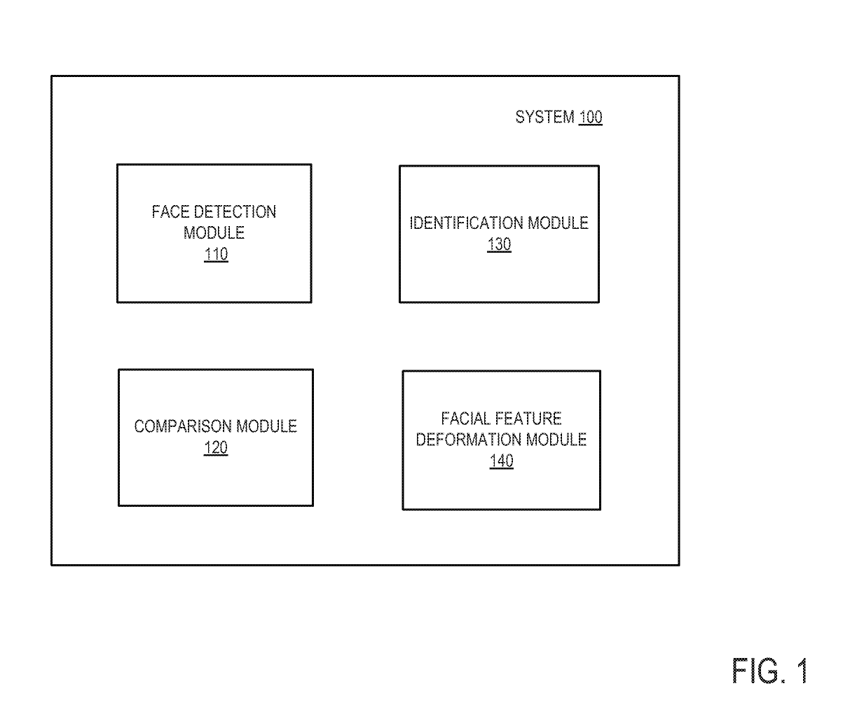

FIG. 1 is a block diagram illustrating a system according to various embodiments. FIG. 1 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

System 100 includes a face detection module 110 to detect faces within digital images. In particular, face detection module 110 detects faces within a series of imaging frames. The series of imaging frames can be captured by system 100 (e.g., via an imaging sensor) or they can be imported, downloaded, etc. to system 100. The series of imaging frames can be associated with a video segment in some embodiments. In other embodiments, the imaging frames can be associated with a series of still images or photographs (e.g., taken in succession, burst mode, etc.). Thus, as used herein, an imaging frame refers to any digital image that shares temporal and spatial (i.e., subject, scene, etc.) proximity with other digital images in a group or series.

Facial feature deformation module 140 detects facial feature deformations within the faces detected by face detection module 110. In particular, facial feature deformation module 140 quantifies changes to facial feature deformations in progressive frames of a group or series of imaging frames. For example, facial feature deformation module 140 might detect a mouth smiling in one imaging frame and then detect the mouth changing from a smile to a frown over the course of several subsequent imaging frames. Facial feature deformation module 140 may quantify the change of the mouth in a variety of ways. For example, the motion (e.g., velocity) or change in motion (e.g., acceleration) of the mouth as it transitions from smile to frown over the course of progressive imaging frames might be measured and quantified. In another example, the range (e.g., spatial range) of a facial feature deformation might be measured and quantified.

Comparison module 120 compares quantified changes against quantified changes associated with images stored in a facial recognition database. For example, if facial feature deformation module 140 determined that a particular facial feature deformation had a velocity of X, the velocity X could be compared against velocities of similar facial feature deformations associated with images in a facial recognition database. The facial feature recognition database is accessed via a network connection some embodiments, but it could be maintained locally (e.g. on system 100) in other embodiments.

Identification module 130 uses comparison results from comparison module 120 to identify faces. In particular, identification module 130 identifies faces based on comparing the quantified changes to quantified changes in the facial recognition database. For example, if comparison module 120 determines that a velocity of mouth movement associated with a detected face matches a velocity of mouth movement associated with Jane's face in the database, identification module 130 might identify the detected face as being that of Jane. Of course, identification module 130 may use additional factors and/or characteristics (e.g., distance between eyes, shape of nose, etc.) in combination with one or more quantified facial feature deformation changes (e.g., velocity of mouth movement, etc.) to identify a face.

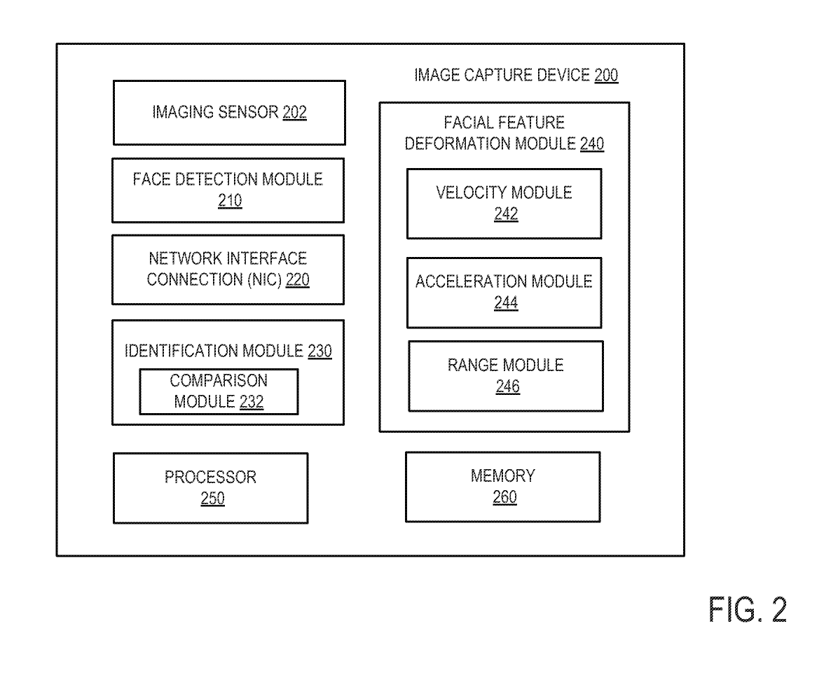

FIG. 2 is a block diagram of an image capture device according to various embodiments. FIG. 2 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

Similar to system 100 of FIG. 1, device 200 includes a face detection module 210 to detect faces within a series of imaging frames. The series of imaging frames could be captured by imaging sensor 202 or they could be imported, downloaded, etc. to device 200.

The series of imaging frames can be associated with a video segment in some embodiments. In other embodiments, the imaging frames can be associated with a series of still images or photographs (e.g., taken in succession, burst mode, etc.). In other embodiments, the imaging frames can be associated with a “live view” display on device 200. Many digital cameras (e.g., including cell phone cameras, etc.), rather than provide a viewfinder for viewing/framing the scene of a picture), use a live view of frames captured by an image sensor (e.g., imaging sensor 202) rendered on a display (e.g., LCD, LED, etc.) of the camera. To provide a suitable live view rendering of the scene, the rate at which frames are captured by the image sensor and rendered to the display may be comparable to the frame rate of a digital video camera. For example, some digital cameras capture still images and video. The frame rate of the live view on such cameras may be the same as or comparable to the frame rate used to capture and store frames in the camera's video capture mode.

Facial feature deformation module 240 detects facial feature deformations within faces detected by face detection module 110. More particularly, facial feature deformation module 240 analyzes a group or series of imaging frames to ascertain changes in facial feature deformations over time. Facial feature deformation module 240 includes a velocity module 242, an acceleration module 244 and a range module 246.

Velocity module 242 determines a velocity associated with facial feature deformations. For example, when a facial feature deformation (e.g., a mouth in a smiling position) changes (e.g., to a mouth in a frowning position), velocity module 242 measures the rate of change (i.e., the velocity) associated with the facial feature deformation. The measured velocity could be an average velocity over time, a velocity at a particular time, a maximum and/or minimum velocity, etc.

Acceleration module 244 determines acceleration associated with facial feature deformations. For example, when a facial feature deformation (e.g., the mouth in the smiling position) changes (e.g., to the mouth in the frowning position), acceleration module 244 measures the change in velocity (i.e., the acceleration) associated with the facial feature deformation. The measured acceleration could be an average acceleration, a maximum and/or minimum acceleration, a measured acceleration at a particular time, etc.

Range module 246 determines a range associated with a characteristic of a facial feature deformation. For example, range module 246 might determine a spatial range of curvature coefficients of a parabola that approximates the curvature of a mouth (e.g., the range from smiling to frowning, etc.). Other suitable ranges could be measured and/or determined in different embodiments.

Identification module 230 uses comparison results to identify faces. Measured velocities, accelerations, ranges, and/or other face recognition data are compared against velocities, accelerations, ranges, and/or other face recognition data associated with images stored in a facial recognition database. The facial recognition database is accessed from a network via a NIC (network interface connection) 220 in some embodiments. In other embodiments, the facial recognition database is maintained locally (e.g., in memory 260). In still other embodiments, a facial recognition profile could be downloaded via NIC 220, the profile containing a subset of a facial recognition database that is associated (e.g., via tagging) with the profile. In embodiments where the facial recognition database is queried (e.g., on a network server via NIC 220), the comparison results may be generated on the network server and returned to identification module 230. In embodiments where the facial recognition database is maintained locally or is downloaded via NIC 220, a comparison module 232 may generate the comparison results.

For example, if it is determined by comparison that a curvature range of a mouth associated with a detected face matches a curvature range associated with Jack's mouth in the database, identification module 230 might identify the detected face as being that of Jack. Of course, identification module 230 may use additional data (e.g., distance between eyes, shape of nose, etc.) in face identification. Face identification results may be used for a variety of purposes, which are beyond the scope of this disclosure.

Various modules and/or components illustrated in FIG. 2 may be implemented as a computer-readable storage medium containing instructions executed by a processor (e.g., processor 250) and stored in a memory (e.g., memory 260).

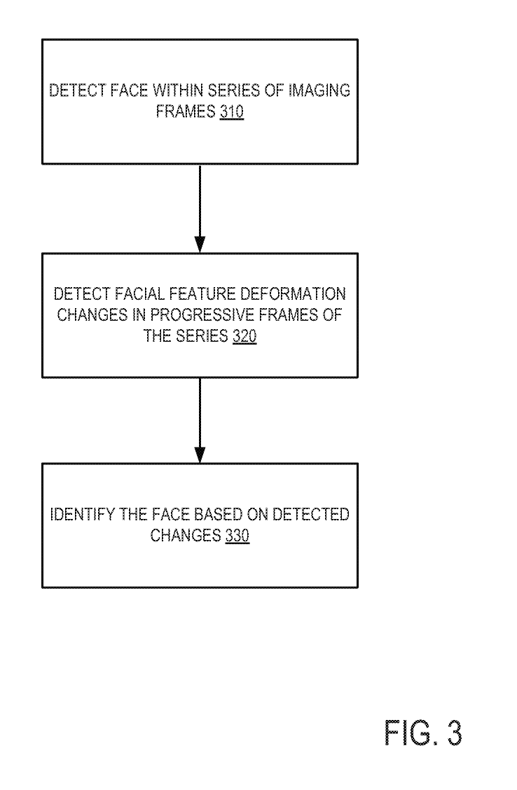

FIG. 3 is a flow diagram of operation in a system according to various embodiments. FIG. 3 includes particular operations and execution order according to certain embodiments. However, in different embodiments, other operations, omitting one or more of the depicted operations, and/or proceeding in other orders of execution may also be used according to teachings described herein.

A face is detected 310 within a series of imaging frames. As discussed previously, an imaging frame refers to a digital image that shares temporal and spatial (i.e., subject, scene, etc.) correlation with other digital images in a group or series. For example, a digital video segment is comprised of a series of imaging frames. A live view display on a digital camera is composed of a series of imaging frames as well. In yet another example, a group of photos taken using a burst mode or similar camera mode may also represent a series of imaging frames. The detected face may be that of a human face, but could also be the face of animal (e.g., cat, dog, etc.). Also, multiple faces could be detected in the series of imaging frames.

Facial feature deformations are identified within detected faces. One example of a facial feature that is prone to deformation is the mouth. A mouth shape and/or mouth position may change (e.g., from a neutral position to a smile, etc.) over time (i.e., over the course of progressive imaging frames). Thus, over the course of progressive imaging frames in the series, changes to facial feature deformations are detected 320. While the progressive imaging frames may be consecutive, they may be intermittent progressive frames in some embodiments.

Based on one or more detected changes to one or more facial feature deformations, the detected face is identified 330. For example, changes (e.g., velocity, acceleration, spatial range, etc.) may be compared against known changes associated with images stored in a facial recognition database. The facial recognition database could be one that is queried on a network or it could be one that is downloaded and/or maintained locally.

Various modifications may be made to the disclosed embodiments and implementations of the invention without departing from their scope. Therefore, the illustrations and examples herein should be construed in an illustrative, and not a restrictive sense.

1. A method, comprising:
detecting a face within a series of imaging frames;
detecting one or more changes of a facial feature associated with the face in progressive frames of the series; and
identifying the face based at least in part on the detected changes.

2. The method of claim 1, wherein detecting one or more changes of the facial feature comprises:
measuring a range of a characteristic of the facial feature in frames of the series.

3. The method of claim 2, wherein measuring a range of a characteristic of the facial feature comprises:
measuring a spatial range of the facial feature in frames of the series.

4. The method of claim 1, wherein detecting one or more changes of the facial feature comprises:
determining a velocity of the one or more changes of the facial feature in frames of the series.

5. The method of claim 1, wherein detecting one or more changes of the facial feature comprises:
determining an acceleration of the one or more changes of the facial feature in frames of the series.

6. An apparatus, comprising:
a face detection module to detect a face within a frame associated with a live image preview;
a facial feature deformation module to detect and quantify a change of a facial feature associated with the face in progressive frames of the live image preview; and
an identification module to identify the face based at least in part on comparing the quantified change against quantified changes associated with images stored in a facial recognition database.

7. The apparatus of claim 6, wherein the facial feature deformation module further comprises a velocity module to determine a velocity associated with the facial feature; and
wherein the identification module further comprises a comparison module to compare the velocity against facial feature velocities associated with images in the facial recognition database.

8. The apparatus of claim 6, wherein the facial feature deformation module further comprises an acceleration module to determine acceleration associated with the facial feature; and
wherein the identification module further comprises a comparison module to compare the acceleration against facial feature accelerations associated with images in the facial recognition database.

9. The apparatus of claim 6, wherein the facial feature deformation module further comprises a range module to determine a range of the facial feature; and
wherein the identification module further comprises a comparison module to compare the range against facial feature ranges associated with images in the facial recognition database.

10. The apparatus of claim 9, the range module further to determine a spatial range of the facial feature.

11. A computer-readable storage medium containing instructions, that when executed, cause a computer to:
detect a face within a series of image frames;
detect one or more changes of a facial feature associated with the face in progressive frames of the series; and
identify the face based at least in part on the detected changes.

12. The computer-readable storage medium of claim 11, wherein the instructions that cause the computer to detect one or more changes comprise further instructions that cause the computer to:
measure a range of a characteristic of the facial feature in frames of the series.

13. The computer-readable storage medium of claim 11, wherein the instructions that cause the computer to detect one or more changes comprise further instructions that cause the computer to:
measure a spatial range of the facial feature in frames of the series.

14. The computer-readable storage medium of claim 11, wherein the instructions that cause the computer to detect one or more changes comprise further instructions that cause the computer to:
determine a velocity of the one or more changes of the facial feature in frames of the series.

15. The computer-readable storage medium of claim 11, wherein the instructions that cause the computer to detect one or more changes comprise further instructions that cause the computer to:
determine an acceleration of the one or more changes of the facial feature in frames of the series.
